(19) United States
(12) Patent Application Publication
(10) Pub. No.: US 2006/0120831 A1
(43) Pub. Date: Jun. 8, 2006

(54) Tandem motor scraper

(76) Inventor: Harold Dale Haugen, Bengough (CA)

Correspondence Address: LAW OFFICES OF ALBERT WAI-KIT CHAN, LLC, WORLD PLAZA, SUITE 604, 141-07 20TH AVENUE, WHITESTONE, NY, 11357, US

(21) Appl. No.: 11/191,713

(22) Filed: Jul. 28, 2005

(30) Foreign Application Priority Data
Nov. 5, 2004 (CA) 2,486,843

(51) Int. Cl. B65G 57/00

(52) U.S. Cl. 414/133

(57) ABSTRACT

A method of connecting a tandem bucket assembly to a conventional motor scraper comprises detaching a bucket frame mounted on wheels on an axle from a second conventional motor scraper and adding a gooseneck arm to the front end of the bucket frame to form the tandem bucket assembly. The tandem bucket assembly is connected to the conventional motor scraper by connecting a front end of the gooseneck arm to the conventional motor scraper at a pivoting connection located forward of the rear axle of the conventional motor scraper and behind a bucket of the conventional motor scraper. Bucket controls are mounted on the conventional motor scraper to operate a tandem bucket on the tandem bucket assembly.

This application claims priority of Canadian Application No. 2,486,843, filed Nov. 5, 2004. The contents of which are hereby incorporated in their entireties by reference into this application.

This invention is in the field of earth moving equipment and in particular motor scrapers.

### BACKGROUND

Motor scrapers are well known for moving earth. These motor scrapers generally comprise a rear bucket frame on a set of rear wheels connected to a front operator frame on a set of front wheels by an articulating connection, and hydraulic cylinders that pivot the frames with respect to each other to steer the motor scraper. The operator's platform and motor are mounted on the operator frame, and a bucket or bowl for carrying earth is mounted on the bucket frame. A blade at a forward edge of the bucket scrapes earth from the ground surface. Controls are provided to the operator for raising and lowering the blade, filling the bucket, emptying the bucket, and so forth.

Such motor scrapers are illustrated generally for example in U.S. Pat. No. 4,580,801 to Suketomo et al., and U.S. Pat. No. 3,563,328 to Ahola et al. These patents illustrate a motor scraper having a motor on both the operator and bucket frames so that the front and rear sets of wheels are both driven. Such motor scrapers are also known where only the front wheels are driven, however such motor scrapers with a single motor typically require a separate tractor to push them during loading.

In order to reduce manpower requirements, and increase efficiency it has also been known to connect the bucket frame of one motor scraper to the bucket frame of another motor scraper with a suitable pivoting hitch to form a tandem motor scraper with one operator frame and two bucket frames aligned behind the operator frame. Such prior art tandem motor scrapers worked satisfactorily in open work areas where tight turns were not required. They were however somewhat limited in their operations since the rear bucket frame would contact the middle bucket frame during tight turns. As well, if it was desired to detach the rear bucket frame to form a conventional motor scraper for use in more constricted work areas, considerable time and effort was required.

### SUMMARY OF THE INVENTION

It is an object of the present invention to provide a tandem motor scraper that overcomes problems in the prior art.

The present invention provides in one embodiment, a tandem motor scraper apparatus comprising a front operator frame mounted on front wheels on a front axle and having a front motor driving the front wheels. A middle bucket frame is mounted on middle wheels on a middle axle and is connected to the operator frame rearward of the operator frame by an articulating connection such that the middle bucket frame can pivot with respect to the operator frame about a vertical steering axis to steer the apparatus. A rear bucket frame is mounted on rear wheels on a rear axle and has a gooseneck arm extending forward from the rear bucket frame and connected to the middle bucket frame by a pivoting connection located forward of the middle axle. Bucket controls mounted on the operator frame manipulate front and rear buckets mounted on respective middle and rear bucket frames.

In a second embodiment the invention provides a method of connecting a tandem bucket assembly to a conventional motor scraper comprising detaching a bucket frame mounted on wheels on an axle from a second conventional motor scraper and adding a gooseneck arm to the front end of the bucket frame to form the tandem bucket assembly; connecting the tandem bucket assembly to the conventional motor scraper by connecting a front end of the gooseneck arm to the conventional motor scraper at a pivoting connection located forward of the rear axle of the conventional motor scraper and behind a bucket of the conventional motor scraper; and providing bucket controls mounted on the conventional motor scraper to operate a tandem bucket on the tandem bucket assembly.

The tandem motor scraper of the invention, with the rear bucket frame pivotally attached to the middle bucket frame forward of the middle axle, can turn sharper than tandem motor scrapers of the prior art, and thus provides considerable advantages in maneuverability over the prior art. The rear bucket can also be detached readily at a ball and socket connection so that the conventional motor scraper can operate conventionally if desired. Conveniently the ball and socket connection is located above the middle motor to facilitate connecting and detaching the rear bucket, and jacks and stands are provided to facilitate removal and parking of the rear bucket.

### DESCRIPTION OF THE DRAWINGS

While the invention is claimed in the concluding portions hereof, preferred embodiments are provided in the accompanying detailed description which may be best understood in conjunction with the accompanying diagrams where like parts in each of the several diagrams are labeled with like numbers, and where:

FIG. 1 is a perspective side view of an embodiment of a tandem motor scraper of the invention;

FIG. 2 is a schematic top view of the embodiment of FIG. 1 moving in a straight forward direction;

FIG. 3 is a schematic top view of the embodiment of FIG. 1 making a turn;

FIG. 4 is a schematic top view of the embodiment of FIG. 1 at its limit of turning;

FIG. 5 is a schematic top view of a prior art tandem motor scraper moving in a straight forward direction;

FIG. 6 is a schematic top view of the prior art tandem motor scraper of FIG. 5 at its limit of turning;

FIG. 7 is a schematic view of the bucket controls of the embodiment of FIG. 1.

### DETAILED DESCRIPTION OF THE ILLUSTRATED EMBODIMENTS

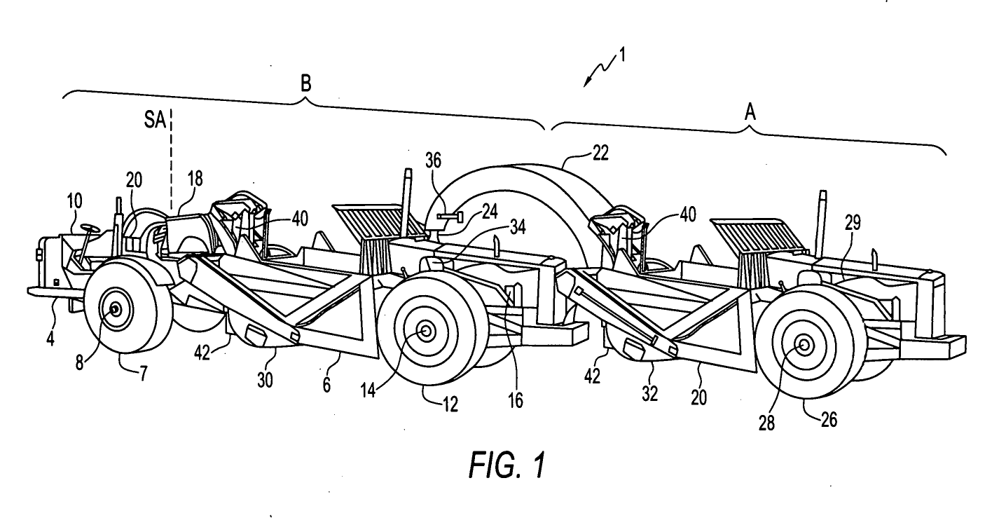

FIG. 1 illustrates a tandem motor scraper apparatus 1 of the present invention. The motor scraper apparatus 1 comprises a front operator frame 4 and a middle bucket frame 6 connected to the operator frame 4 rearward of the operator frame 4 by an articulating connection 8 such that the middle bucket frame 6 can pivot with respect to the operator frame 4 about a vertical steering axis SA to steer the apparatus 1.

The front operator frame 4 is mounted on front wheels 7 on a front axle 8 and has a front motor 10 driving the front wheels 7. The middle bucket frame 6 is similarly mounted on middle wheels 12 on a middle axle 14. The illustrated embodiment has a middle motor 16 operative to drive the middle wheels 12. The illustrated front operator frame 4 and a middle bucket frame 6 connected by an articulating connection 18 can be provided by a conventional motor scraper such as is known in the prior art.

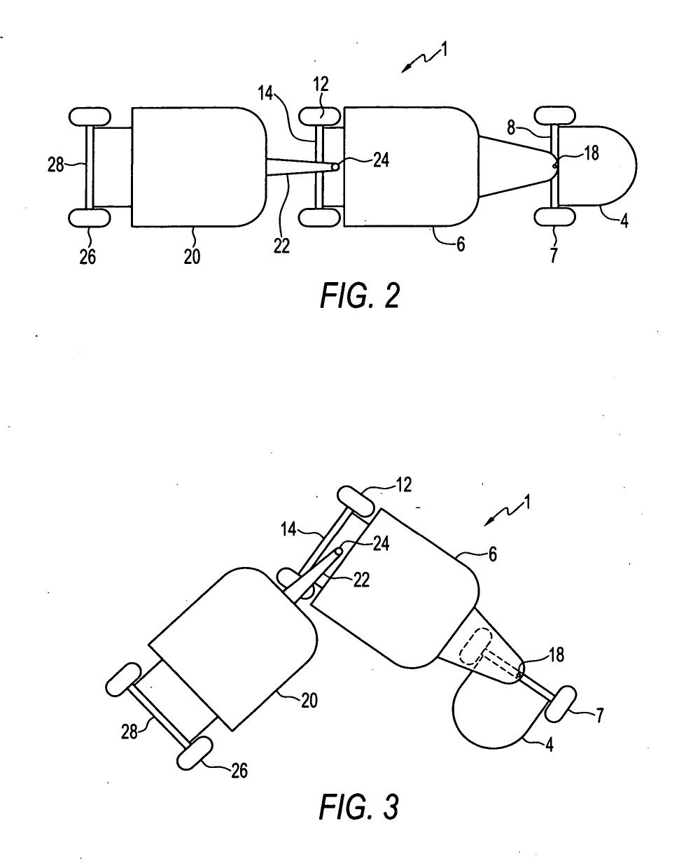

A rear bucket frame 20 has a gooseneck arm 22 fixed to the front end thereof and extending forward over the middle motor 16. The front end of the gooseneck arm 22 is connected to the middle bucket frame 6 by a pivoting connection, provided in the illustrated embodiment by a ball and socket connection 24, located forward of the middle axle 14, as schematically illustrated in FIG. 2. The rear bucket frame 20 is mounted on rear wheels 26 on a rear axle 28. The ball and socket connection 24 allows the rear bucket frame 20 to twist and turn with respect to the middle bucket frame 6 to follow ground contours and turn corners. In the illustrated embodiment a rear motor 29 is operative to drive the rear wheels 26.

Bucket controls 20 are mounted adjacent to the operator's seat on the operator frame 4 to manipulate front and rear buckets 30, 32 mounted on respective middle and rear bucket frames 6, 20.

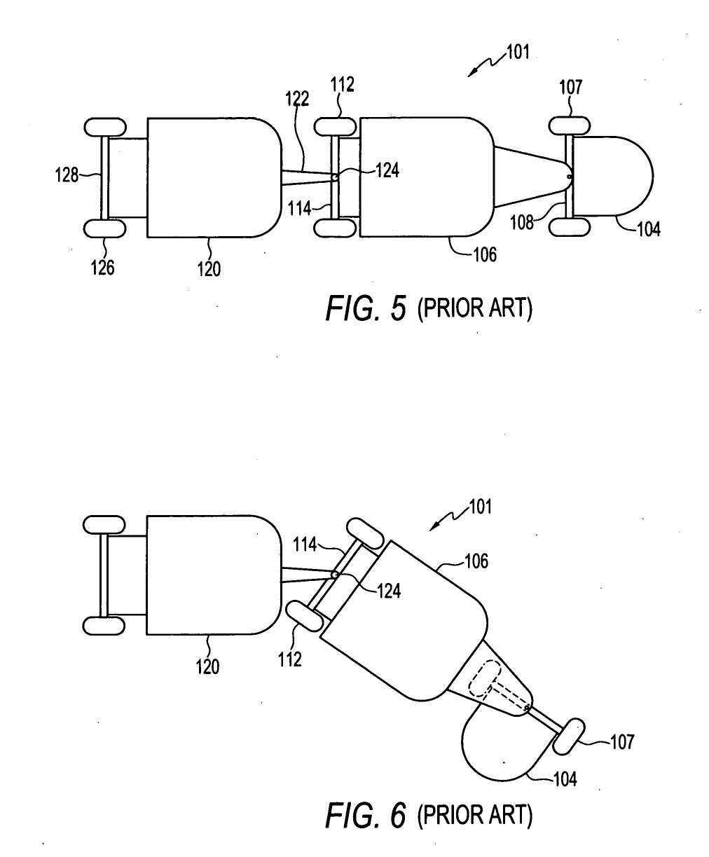

FIG. 5 illustrates a tandem motor scraper apparatus 101 of the prior art moving in a straight forward direction, and FIG. 6 illustrates the prior art tandem motor scraper apparatus 101 making a turn. The gooseneck arm 122 that connects the rear bucket frame 120 to the middle bucket frame 106 is connected to a ball and socket connection 124 that is located substantially on the middle axle 114. Thus when making the turn illustrated in FIG. 6, the middle wheels 112 contact the rear bucket frame 120. The turn is shown as being limited by the middle wheels 112 contacting the rear bucket frame 120 for illustrative purposes. In the prior art the turn could also be limited by portions of the middle bucket frame 106 contacting the rear bucket frame 120, but the illustration in any event illustrates the problem. The turning radius must therefore be limited to prevent damage to the motor scraper apparatus 101 from such contact.

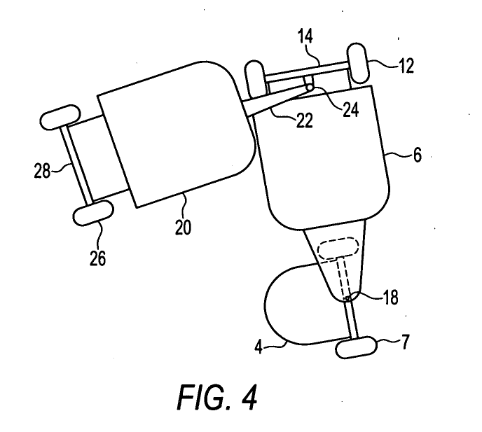

In contrast the turning abilities of the motor scraper apparatus 1 of the present invention are illustrated in FIGS. 2, 3 and 4. FIG. 2 illustrates the tandem motor scraper apparatus 1 moving in a straight forward direction and with the rear bucket frame 20 the same distance behind the middle bucket frame 6 as in the prior art apparatus of FIG. 5. The gooseneck arm 22 however is longer and the ball and socket connection 24 is located in this apparatus 1 is forward of the middle axle 14. FIG. 3 illustrates the tandem motor scraper apparatus 1 making a turn that is much tighter than that allowed by the arrangement of the prior art motor scraper apparatus 101 as illustrated in FIG. 6. FIG. 4 illustrates the limit of the turn that can be made before the rear bucket frame 20 contacts the middle bucket frame 6. At that point the operator frame 4 is turned more than 180° relative to the rear bucket frame 20.

With the ball and socket connection 24 located forward of the middle axle 14, as the middle bucket frame pivots with respect to the rear bucket frame, the pivot point at the ball and socket connection 24 moves rearward as well as laterally and pushes the rear bucket frame 6 rearward to provide added clearance to allow for tighter turns.

As illustrated in FIG. 1 the ball and socket connection 24 is located above the middle motor 16. The ball of the ball and socket connection 24 is mounted on a frame extension 34 extending upward from the motor portion of the middle bucket frame 6. The ball and socket connection 24 is thus easily accessible and further when the gooseneck arm 22 is disconnected from the ball and socket connection 24, the middle bucket frame can simply be moved forward under the gooseneck arm 22 to remove the rear bucket frame 20 from the middle bucket frame 6. The operator frame 4 and middle bucket frame 6 can then be operated as a conventional motor scraper.

Constructing and mounting the frame extension 34 so that the ball and socket connection 24 is properly located can involve re-locating components such as fuel tanks, guards, and the like however such modifications as are required will be readily discerned and accomplished by those skilled in the art.

In the embodiment of FIG. 1, a jack 36, shown in the stored position, can be pivoted down and operated to bear against the frame extension 34 and thus exert an upward force between the middle bucket frame 6 and the gooseneck arm 22 to raise the gooseneck arm 22 and disconnect the ball and socket connection 24. Stands 36 are mounted on the rear bucket frame 20 such that the stands 36 can be moved from the illustrated transport position, where the stands 36 are raised above the ground, to a parking position wherein the stands 36 maintain the gooseneck arm 36 in a raised parked position so that the middle bucket frame 6 can be moved away.

To facilitate convenient connection and detachment of the rear bucket frame 20 releasable couplers are provided in each of a plurality of hydraulic conduits and air conduits extending between the middle bucket frame 6 and rear bucket frame 20 adjacent to the ball and socket connection 24. Such conduits carry hydraulic fluid for operating the rear bucket 32, and air 25 to operate the throttle on the rear motor 29 and the brakes on rear wheels 26.

The middle and rear buckets 30, 32 are manipulated by hydraulic cylinders 40. Typically as in conventional motor scrapers, three functions are controlled individually by the hydraulic cylinders 40. One set of hydraulic cylinders raise and lower the bucket, one set raises and lowers the apron 42 to open and close the front end of the bucket, and one set moves the tailgate of the bucket, not visible in the drawings, upward and forward to dump the bucket. Thus three different control levers are conventionally located at the operator's position in a motor scraper, one to operate the hydraulic cylinders for each function of the bucket. Each lever operates a valve to control a flow of pressurized hydraulic fluid from the pressurized hydraulic fluid source to the hydraulic cylinders 40, and to control the flow of return hydraulic fluid from the hydraulic cylinders 40 to a reservoir.

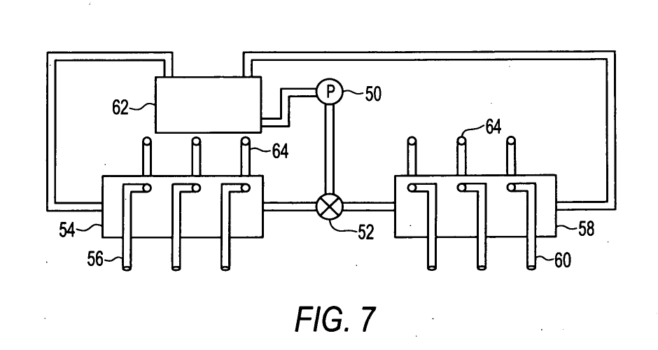

FIG. 7 illustrates the bucket controls 20 of the present invention. The pressurized hydraulic fluid source is the output of a hydraulic pump 50 driven by the front motor. A selector valve 52 operative to direct pressurized hydraulic fluid from the pump 50 through either middle bucket control valve 54 to middle bucket hydraulic cylinders via middle conduits 56 or through rear bucket control valves 58 to rear bucket hydraulic cylinders via rear conduits 60. The pump capacity is typically only sufficient to operate one bucket 30, 32 at a time, and so by moving the selector valve to the middle or rear position the operator can select which bucket can be operated. Once one bucket is set at the desired position, the operator can switch to the other and set it. The operator can make adjustments to either simply by moving the selector valve 52 to the middle or rear position. Conveniently the selector valve 52 is switched by an air or electric control.

Typically the middle and rear hydraulic cylinders are single acting, in that pressurized hydraulic fluid flows through a conduit to each hydraulic cylinder to raise either the apron, bucket, or tailgate in response to manipulation of the middle and rear bucket control valves 54, 58, and then flows back through the same conduit when the middle and rear bucket control valves 54, 58 are manipulated to lower the apron, bucket, or tailgate. When lowering, the control valves 54, 58 only open a path and allow the hydraulic fluid that is under the pressure of the weight of the apron, bucket, or tailgate to flow to the reservoir 60. When lowering the control valves do not need to be connected to the pump 50. Thus conveniently the system is configured such that regardless of the position of the selector valve 52, the middle and rear bucket control valves 54, 58 can be manipulated to allow return hydraulic fluid to flow from respective middle and rear hydraulic cylinders 40 to the hydraulic fluid reservoir 62 and lower the apron, bucket, or tailgate.

It is contemplated that hydraulic controls using other configurations, such as are well known in the art, could provide the required control of the middle and rear bucket functions as well.

The invention provides essentially a method of connecting a tandem bucket assembly A to a conventional motor scraper B as illustrated in FIG. 1. The tandem bucket assembly A is provided by detaching a bucket frame 20 mounted on wheels 26 on an axle 28 from a second conventional motor scraper, and adding the gooseneck arm 22 to the front end of the bucket frame 20. The tandem bucket assembly A is connected to the conventional motor scraper B by connecting the front end of the gooseneck arm 22 to the conventional motor scraper B at a pivoting connection, illustrated as ball and socket connection 24, located forward of the rear axle 14 of the conventional motor scraper B and behind the bucket 30 of the conventional motor scraper B. Bucket controls 20 are mounted on the conventional motor scraper B to operate the tandem bucket 32 on the tandem bucket assembly B.

The foregoing is considered as illustrative only of the principles of the invention. Further, since numerous changes and modifications will readily occur to those skilled in the art, it is not desired to limit the invention to the exact construction and operation shown and described, and accordingly, all such suitable changes or modifications in structure or operation which may be resorted to are intended to fall within the scope of the claimed invention.

What is claimed is:

1. A tandem motor scraper apparatus comprising:
a front operator frame mounted on front wheels on a front axle and having a front motor driving the front wheels;
a middle bucket frame mounted on middle wheels on a middle axle and connected to the operator frame rearward of the operator frame by an articulating connection such that the middle bucket frame can pivot with respect to the operator frame about a substantially vertical steering axis to steer the apparatus;
a rear bucket frame mounted on rear wheels on a rear axle and having a gooseneck arm extending forward from the rear bucket frame and connected to the middle bucket frame by a pivoting connection located forward of the middle axle;
bucket controls mounted on the operator frame to manipulate front and rear buckets mounted on respective middle and rear bucket frames.

2. The apparatus of claim 1 further comprising a middle motor mounted on the middle bucket frame and operative to drive the middle wheels, and wherein the gooseneck arm extends over the middle motor.

3. The apparatus of claim 2 wherein the pivoting connection is a ball and socket connection located above the middle motor such that when the gooseneck arm is disconnected from the ball and socket connection the middle bucket frame can be moved forward under the gooseneck arm to remove the rear bucket frame from the middle bucket frame.

4. The apparatus of claim 3 further comprising a plurality of hydraulic conduits extending between the middle bucket frame and rear bucket frame, and comprising releasable couplers in each hydraulic conduit located adjacent to the ball and socket connection.

5. The apparatus of claim 4 further comprising a jack operative to exert an upward force between the middle bucket frame and the gooseneck arm to raise the gooseneck arm and disconnect the ball and socket connection, and further comprising stands mounted on the rear bucket frame such that the stands can be moved from a transport position where the stands are raised above the ground, to a parking position wherein the stands maintain the gooseneck arm in a raised position.

6. The apparatus of claim 1 wherein the middle and rear buckets are manipulated by hydraulic cylinders, and wherein the bucket controls comprise valves operative to control a flow of pressurized hydraulic fluid from the source to the hydraulic cylinders, and operative to control a flow of return hydraulic fluid from the hydraulic cylinders to a reservoir.

7. The apparatus of claim 6 wherein the bucket controls further comprise a selector valve operative when in a middle bucket position to direct pressurized hydraulic fluid from the source through middle bucket control valves to middle bucket hydraulic cylinders, and operative when in a rear bucket position to direct pressurized hydraulic fluid from the source through rear bucket control valves to rear bucket hydraulic cylinders.

8. The apparatus of claim 7 wherein the middle and rear bucket control valves are operative to allow return hydraulic fluid to flow from respective middle and rear hydraulic cylinders to the reservoir when the selector valve is in the middle bucket position and when the selector valve is in the rear bucket position.

9. The apparatus of claim 1 further comprising a rear motor mounted on the rear bucket frame and operative to drive the rear wheels.

10. A method of connecting a tandem bucket assembly to a conventional motor scraper comprising:
detaching a bucket frame mounted on wheels on an axle from a second conventional motor scraper and adding a gooseneck arm to the front end of the bucket frame to form the tandem bucket assembly;
connecting the tandem bucket assembly to the conventional motor scraper by connecting a front end of the gooseneck arm to the conventional motor scraper at a pivoting connection located forward of the rear axle of the conventional motor scraper and behind a bucket of the conventional motor scraper;
providing bucket controls mounted on the conventional motor scraper to operate a tandem bucket on the tandem bucket assembly.

11. The method of claim 11 wherein the tandem bucket assembly includes a motor driving the wheels thereof.

12. The method of claim 10 wherein the pivoting connection is provided by a ball and socket connection located above the motor such that when the gooseneck arm is disconnected from the ball and socket connection the conventional motor scraper can be moved forward under the gooseneck arm to remove the tandem bucket assembly from the conventional motor scraper.

13. The method of claim 12 wherein the bucket controls control a flow of pressurized hydraulic fluid through a plurality of hydraulic conduits extending between the conventional motor scraper and tandem bucket assembly, and comprising releasable couplers in each hydraulic conduit located adjacent to the ball and socket connection.
